(19) United States
(12) Patent Application Publication
(10) Pub. No.: US 2012/0135197 A1
(43) Pub. Date: May 31, 2012

(54) COMPOSITE TOOL PIN

(76) Inventor: Ben Halford, Oakham (GB)

(21) Appl. No.: 13/388,986

(22) PCT Filed: Aug. 6, 2010
(86) PCT No.: PCT/GB10/01481

§ 371 Date: Feb. 7, 2012

(30) Foreign Application Priority Data
Aug. 7, 2009 (GB) 0913847.0

(51) Int. Cl. B32B 7/02; B32B 5/16; B32B 3/30

(52) U.S. Cl. 428/161; 428/212; 428/221

(57) ABSTRACT

An element for a tooling system comprising a plurality of elements arranged in an array to form a tool face,the element comprising: a first end having attachment means for attachment to a tool bed, a second end comprising a section of a tool face: wherein the element is a composite element comprising: a first section of a first material having a first coefficient of thermal expansion, the first end being a free end of the first section, and a second section substantially of a second material having a second coefficient of thermal expansion, the second being a free end of the second section, and wherein the first coefficient of thermal expansion is lower than the second coefficient of thermal expansion.

### BACKGROUND

This invention related to a composite tool element, in particular this invention relates to a composite tool element for use in a tooling system comprising a plurality of elements arranged in an array to form a tool face.

Accurate molding of composite parts is typically done in two part tools, in Which the part is pressed and often heated. One method involves placing an un-consolidated, or an uncured pre-formed composite part between two mold tools. The entire Mold tool is then placed in an autoclave and slowly heated to a set temperature and then cooled. Pressure is applied to the mold during the heating stage. As many composite materials are heated in such molds they undergo a reduction in size as the composite consolidates. Typically, as pressure is being applied from one side, as the pressure is applied, and the material consolidates, there will be a movement of the alignment of any reinforcing fibers within the composite parts. As one side of the mold is the datum face there is only lent of material on one side of the article. As such the alignment of reinforcing fibers is distorted causing a change in the mechanical strength of the properties. While some attempt may be made to pre-empt this in the way in which the preformed part is made, this is not usually done as the deformation is not highly predictable and the complexity of the manufacture of the preforms is significantly increased. In the worst case, sheets of reinforcement material or fabric may become creased or folded causing weakness in the molded part. Any weakness is particularly problematic in the high performance applications that some such molded parts are applied in, for example in turbine blades for the aeronautical industry. Furthermore, as the tool often applies pressure to the pre-form to compress it to its consolidated dimensions, large mold presses are required.

Another problem associated with the above mentioned process is that often the preform will be too large to fit in the final mold so a two-step process is used wherein the perform is first placed in a de-bulking mold where it is pressed under very large pressures to compress it substantially to its final dimensions and then it is placed in a final tool in which it is heated so as to consolidate the material. The use of a two part process has obvious cost and process time implications and complicates the procedure. When composite parts having a complex geometry are being formed using heated molding processes, for example an autoclave or resin transfer molding, changes in mold dimension due to thermal expansion and contraction to of the tool can cause undesirable effects in the final dimensions of the molded part as the two tool surfaces of the mold may close together at different rates depending on the thickness of the mold material at different positions. In attempt to mitigate such effects matched metal tooling using materials having a very low coefficient of thermal expansion, for example Invar, is often used. However, these materials are invariably very expensive due to their high nickel content making the cost of such tooling hard to justify except for exceptionally high value items.

### SUMMARY

The present invention attempts to mitigate at least some of the known problems with existing tooling.

According to a first aspect of the present invention there is provided an element for a tooling system comprising a plurality of elements arranged in an allay to form a tool face, the element comprising: a first end having attachment means for attachment to a tool bed, a second end comprising a section of a tool face; wherein the element is a composite element having a first section of a first material having a first coefficient of thermal expansion and a second section of a second material having a second coefficient of thermal expansion, the first coefficient of thermal expansion being lower than the second coefficient of thermal expansion

The thermal expansion of the element can therefore be controlled by the ratio of the first section to the second section. In use the expansion and contraction of the mold can be controlled locally as different elements can have different ratios of first to second section.

Preferably the first and second sections of each element comprise a free end and a joined end, in one preferred arrangement the joined ends of the first and second sections substantially Abutting one another. The joined ends of the first and sections may comprise a series of intermeshing castellations separated from one another on the axis perpendicular to the longitudinal axis of the element so as to enable differential sideways expansion and contraction of the two sections relative one another. A resilient material may fill the gaps between the castellations. Preferably the ends of the first and second sections will substantially abut one another so that thermal expansion and contraction in the longitudinal axis of the tool elements can more simply be calculated. In an alternative arrangement the tool element may be provided with an interface layer between the first and second sections that is naturally resilient such that differential sideways expansion and contraction of the sections can be absorbed within the resilient interface layer. If an interface layer is provided, it will be appreciated that the interface layer will only exhibit resilience in a plane perpendicular to the tool axis.

In a preferred arrangement the join surface between the joined ends comprises a three dimensional surface, preferably the three dimensional surface is non-planar.

Heating and cooling of the element may result in the element extending and contracting in a manner so as to change the contour of the section of tool surface at its second end. Preferably, where the join surface between the joined ends comprises a non-planar three. dimensional surface the change in the contour of the section of tool surface is a scaled reflection of the three dimensional join surface, between the first and second sections of each element, in a plane perpendicular the tooling axis. The ratio of the scaled reflection may be directly proportional to the ratio of the first and second coefficients of thermal expansion

In this manner the expansion and contraction of a complex curved tool surface can be managed during thermal cycling such that, in use, the consolidated part from the tool has the same ratios as its pre-form, in the tooling axis, at least. As the parts are kept in proportion as they are consolidated any fabric or fibers within the material pre-form are maintained in alignment and do not become distorted with respect to their original position within the pre-form.

In one preferred arrangement the free end of the first section of the element comprises the first end of the element and the free end of the second section of the element preferably comprises the second end of the element.

In one preferred arrangement the free end of the second section of each element is capped with a layer of material having a low coefficient of thermal expansion. The free end of the second section of each element may have a capped surface thereon which has a second heating/cooling means associated therewith for local heating of the cap. As the cap forms the tool surface this enables independent control of the compression of the work piece including any changes in tool geometry, and the tool face temperature. Thus the heat being put into or taken out of the work piece is independently controlled.

In one embodiment the tool element may comprise a third section of a material having a third coefficient of thermal expansion and a forth section of a material having a forth coefficient of thermal expansion, the third coefficient of thermal expansion being lower than the forth coefficient of thermal expansion and wherein the forth section comprises a second tool surface. In this manner as the tool element is heated and cooled a controlled complex movement of the tool surface can be obtained. In particular the first and third sections combine to create a tool movement in a first direction and the second and forth tool elements combine to create a tool movement in a second direction.

Preferably the element further comprises individually controllable heating and cooling means associated with the first and second sections and with the third and fourth sections respectively.

Each element may comprise an outer layer and a core. The core may comprise a first core section of a first material having a first coefficient of thermal expansion and a second core section of a second material having a second coefficient of thermal expansion, the first coefficient of thermal expansion being lower than the second coefficient of thermal expansion and having a core join surface between the first core section and the second core section comprising a three dimensional surface, the core and outer layer being in contact with one another and wherein the three dimensional core join surface is preferably aligned with the three dimensional element join surface. In an alternative arrangement the outer layer and the core may be separated from one another by a gap.

In a preferred arrangement he element may have internal fluid channels for receiving heating or cooling fluid. In one arrangement the internal fluid channels are contained within the core. In an alternative arrangement the internal fluid channels comprise the gap between the outer layer and the core. By directly heating and cooling the pins the rate of expansion of each element, and therefore the change in the geometry of the tool surface can be controlled locally. This gives great control over the molding process and allows any stresses imparted into the material to be controlled or eliminated as required. In addition by discretely heating the elements it is not necessary to heat the entire molds, for example in an autoclave which is a common process. The use of a core and outer layer arrangement allows for simplified provision of channels for heating and cooling of the pins.

In a preferred arrangement the first material is Invar and the second material is alminum, however any two materials with high and low coefficients of thermal expansion can be used. As the coefficient of thermal expansion for Invar is exceptionally low, it can n many instances he taken as zero, vastly simplifying the calculations needed to obtain the required change in surface geometry of the element.

According to a second aspect of the invention there is provided a tooling system comprising a first plurality of elements according to the first aspect of the invention arranged in an array such that second ends of each element of the first array form a first tool face.

Preferably the tooling system further comprising a second plurality of elements according the first aspect of the invention arranged in an array such that second ends of each element of the second array form a second tool face, the first and second tool faces configured in an opposing arrangement.

The second section of each element may be dimensioned such that, when the elements are arranged an array, there is a small gap between the second sections of adjacent elements.

In one embodiment at least some of the plurality of elements are dimensioned such that at a first temperature the tool surface is oversized for the required tool surface geometry and wherein at a second temperature, higher than the first temperature they expand to form a required first tool surface geometry. The first temperature could be room temperature. In this manner the ease with which parts can be removed from a tool can be increased as at room temperature the tool is pulled away from the molded part. Alternatively, if, for example, the tooling is being used for resin transfer molding, the resin could be injected with the tool at the first temperature so that the resin can quickly and easily be transferred into the tool by virtue of the oversized tool surface geometry and once the resin has been transferred into the tool the tool elements can be heated to bring the tool surface to the desired tool surface geometry.

Optionally, at a third temperature higher than the second temperature at least some of the elements further expand to form a required second tool surface geometry. This could, for example apply a compression to the part being molded during the molding process.

### BRIEF DESCRIPTION OF THE DRAWINGS

Embodiments of the invention will now be described, by way of example only, with reference to the accompanying drawings in which:

FIGS. 1 to 3 show the changes in dimension of a workpiece during molding using current technology;

FIG. 4 shows a single face tooling system according to the second aspect of the invention.

FIG. 5 shows a dual surface tooling system according to the second aspect of the invention.

FIGS. 6 to 9 show side views of elements, for tooling system, according to the first embodiment of the invention; and

FIGS. 10 and 11 show perspective views of elements, for a tooling system, according to the first embodiment of the invention;

FIGS. 12 and 13 show side views of alternative features of elements of a tooling system, according to the first aspect of the invention; FIGS. 14 and 15 show side views of elements, for a tooling system according to the first embodiment of the invention, the elements having internal heating or cooling channels;

FIGS. 16 and 17 show side views of tooling systems according to the second aspect of the invention; and

FIGS. 18 and 19 shows a side view of a tool element having two axis of movement.

### DETAILED DESCRIPTION

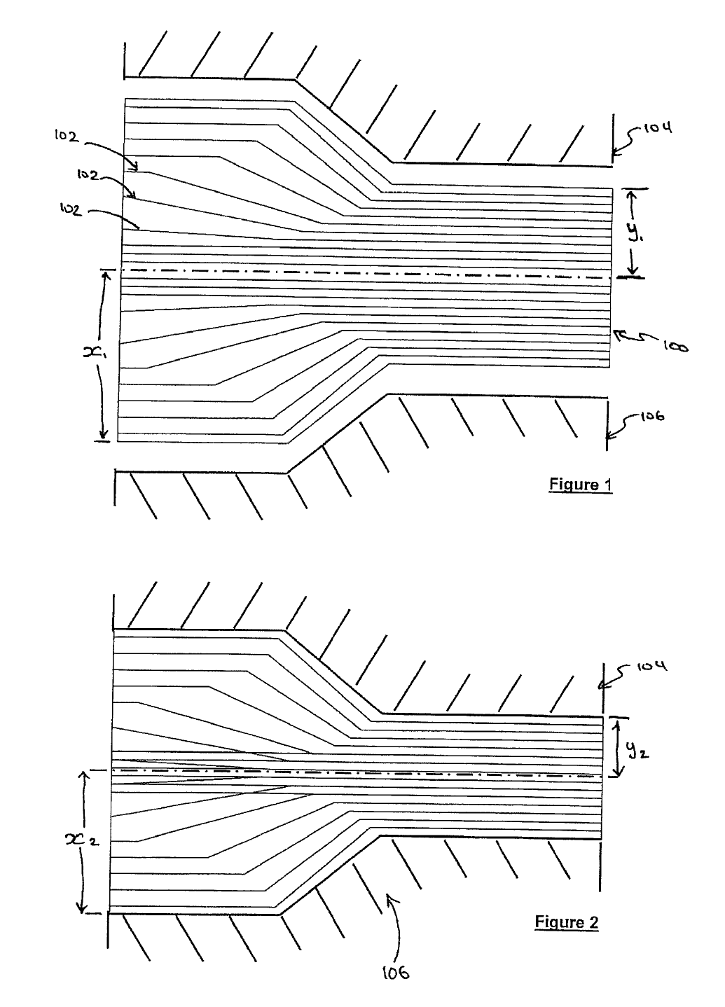

Referring to FIGS. 1 to 3 current state of the art molding processes is described. In FIGS. 1 and 2 a pre-form workpiece 100 comprising fiber 102 reinforced polymer is placed between two molds 104 106. The fiber reinforcement 102 is uniformly distributed across the pre-form 100 in an arrangement that is symmetrical about the center line. The two mold parts 104 106 are then brought together and heat is applied to consolidate the polymer. As the polymer consolidates its dimensions change by a constant percentage. In particular the dimension of the workpiece in the direction substantially perpendicular to the direction of the layers of reinforcement fibers 102 decreases by a constant percentage across the workpiece. As the mold is generally heat cycled as part of the molding process, the tool material may expand and contract during the cycle, imparting stresses into the workpiece 100 as it consolidates. In order to minimize this detrimental effect the mold parts 104 106 are usually made of materials having a very low coefficient of thermal expansion, for example Invar. As the molds are brought together a pressure is applied to ensure full lamination of the fiber layers as the pre-form 100 consolidates.

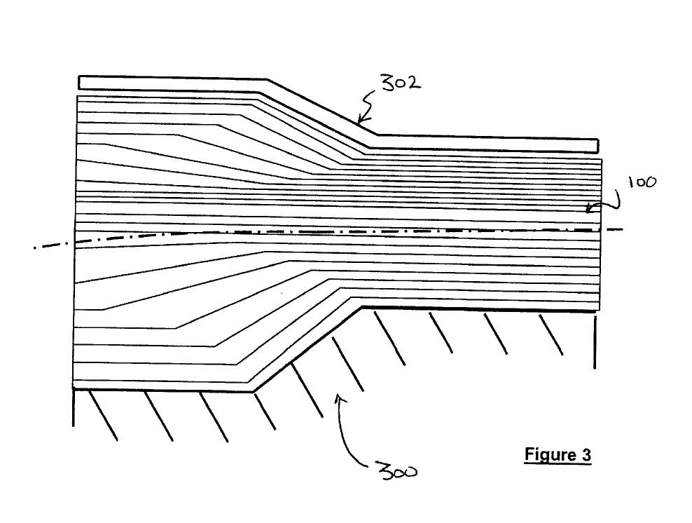

To fully consolidate and allow for the correct dimension change: (XrX2)/Xi=(Yi−Y2)/Yi. i.e. the change in dimension as a percentage of the workpiece depth should be constant. However as the mold surfaces are of fixed dimension, there is a constant value change in dimension rather than a constant percentage change in dimension across the workpiece. This may result in an excessive pressure in the thinner sections, which may squeeze the resin or binder from those sections during consolidation, or a sub optimal pressure in the thicker sections which may result in delaminating or substandard consolidation as the layers pull away from one another, both of which are highly undesirable. Referring to FIG. 3 an alternative process for consolidating a pre-form workpiece 100 is shown in which the mold tool has one solid mold part to 300 and one semi conformative, or conformative tool surface 302. A vacuum is applied under the conformative tool surface 302 such that it applies pressure against the workpiece. In this method of tooling, as the tool surface 302 on one side of the workpiece 100 is conformative, and applies pressure to the workpiece, the majority of the change in dimension of the workpiece as it consolidates occurs on this side of the workpiece. As can be seen from the figure, this has the effect of partially flattening the dimensions on that side of the workpiece and, as the thicker sections will flatten change dimension more dining consolidation there is a shift in the centerline of the workpiece 100. This is highly undesirable in the finished article as, not only is it difficult to keep within part tolerances, but the structural strength and the symmetry of the workpiece is changed.

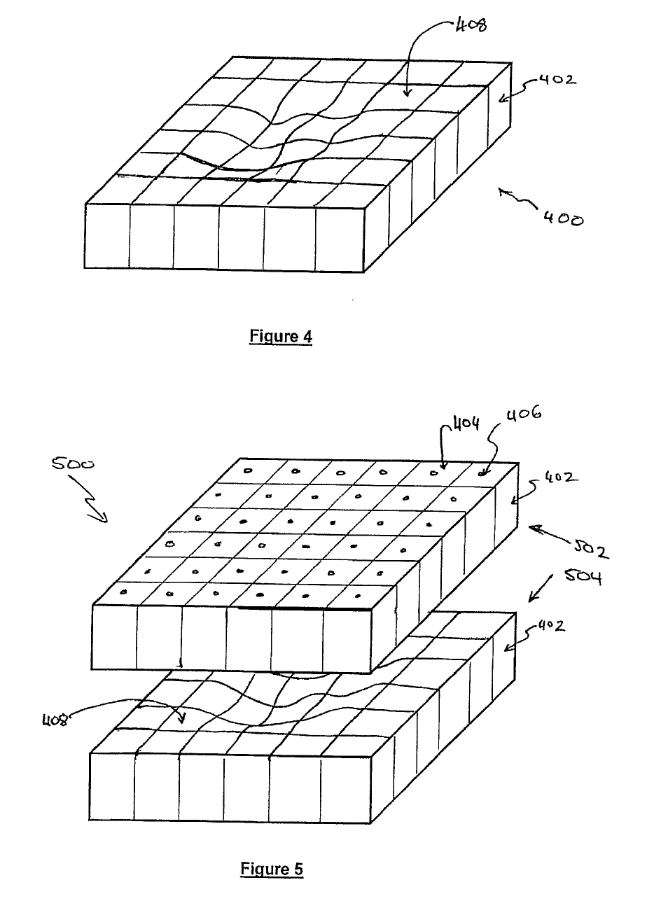

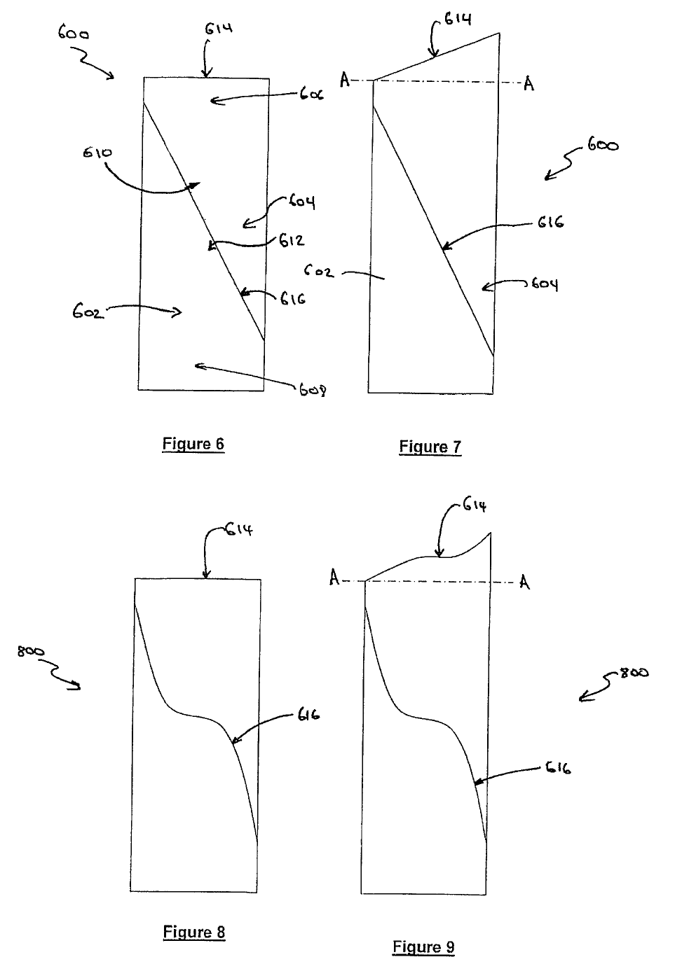

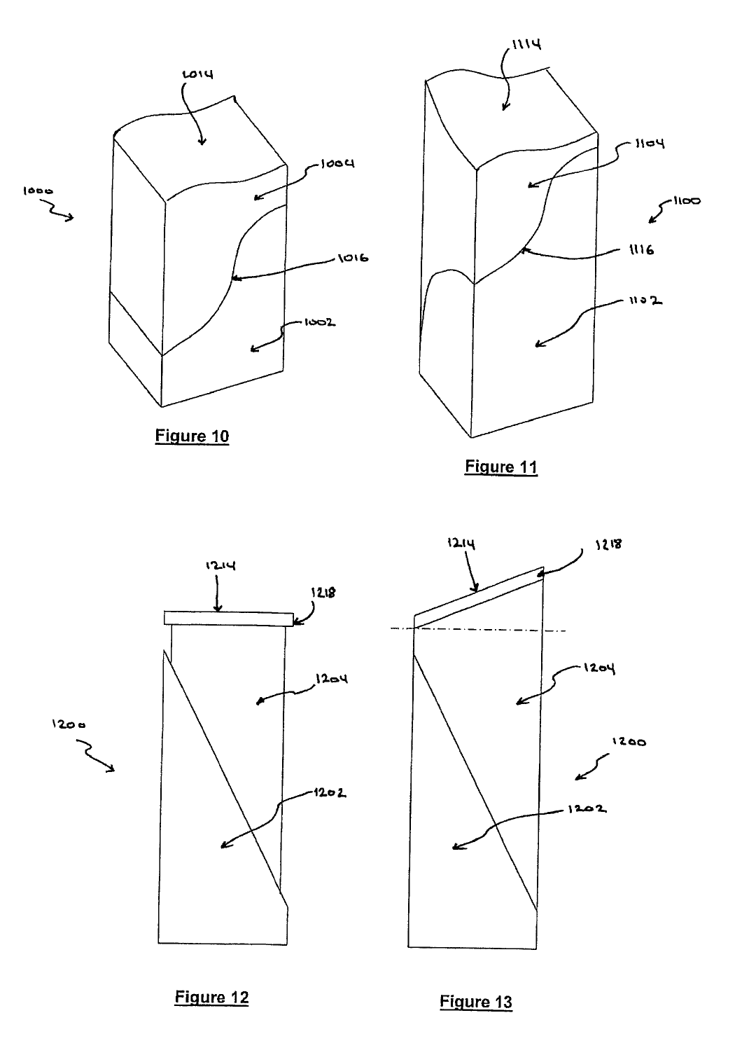

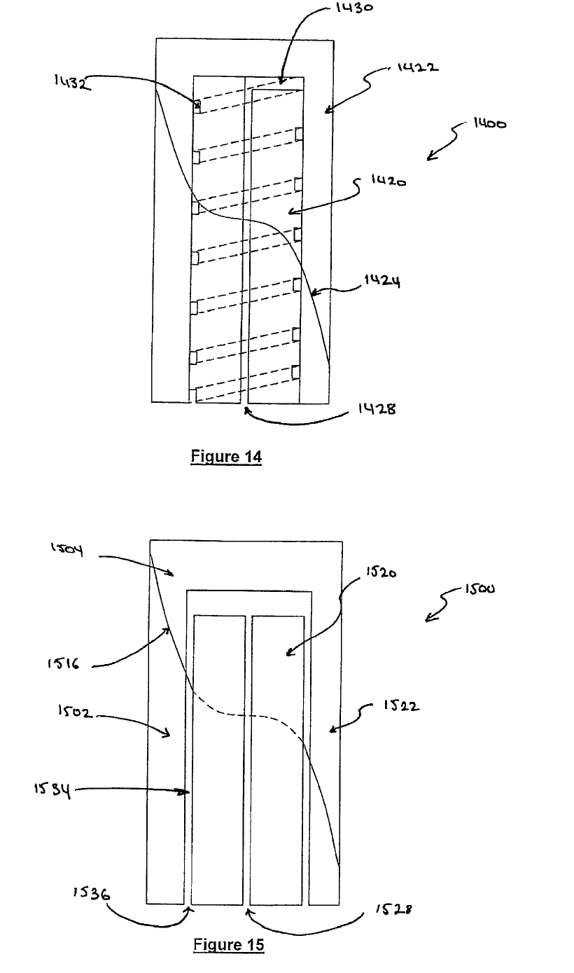

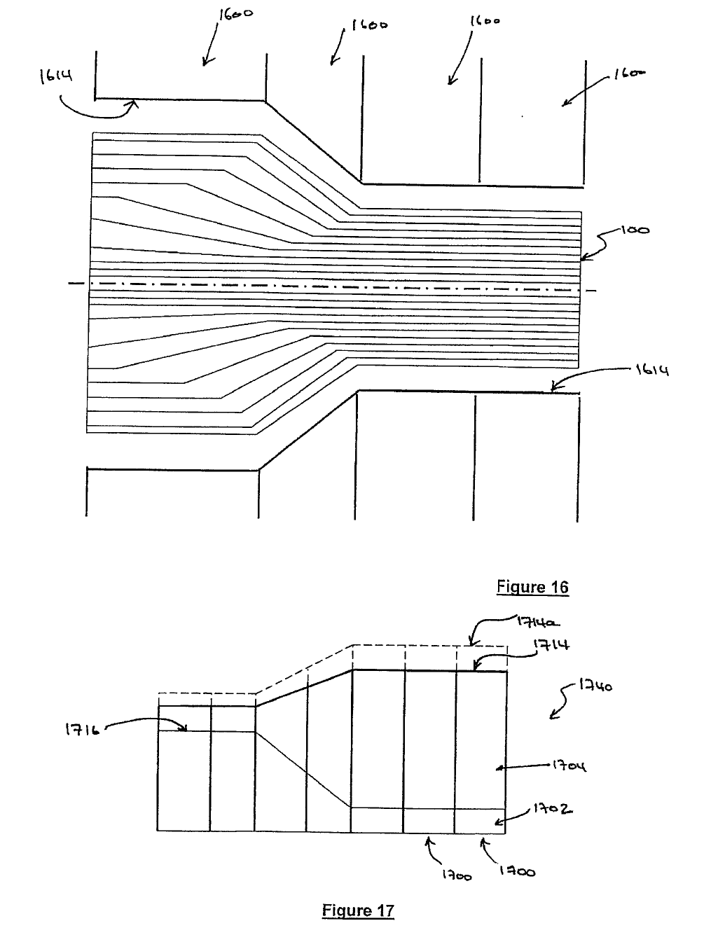

Referring now to FIGS. 4 and 5 a tool system 400, 500 is shown having a plurality of tool elements 402 arranged in an array. The elements each 402 have a first end 404 for attachment to a tool bed, via attachment means 406 and a second end 408 comprising a section of a tool face. In the arrangement shown in FIG. 4 the tool system 400 may be used with a second fixed tool or a second compliant tool surface as known in the art. In the arrangement shown in FIG. 5 the tool system 500 has an upper 502 and a lower 504 tool piece arranged in opposing alignment such that, in use, a pre-form may be placed between the tool pieces, the tool pieces brought together and preferably heated so the pre-form can consolidate in the tooling system. The elements within each array are described in detail with reference to FIGS. 6 to 15.

Referring to FIGS. 6 to 7 a side view of an element 600 for a tooling system is shown in two temperature conditions. The element 600 has a composite structure having a first section 602 of a first material having a first coefficient of thermal expansion (hereinafter CTE) and a second section 604 of a second material having a second CTE, the first CTE being lower than the second CTE. The first 602 and second 604 sections of each element comprise a free 606, 608 end and a joined end 610, 612, the joined ends of the first and second sections substantially abutting one another. The joined ends may be affixed to one another in a number of ways, for example by use of epoxy resins, or by soldering techniques, however any other known methods of joining two dissimilar metals may be used. As will be appreciated, the element 600 is a three dimensional element and the join surface between the two joined ends forms a three dimensional surface. The first section 602 is made of Invar and the second section 604 is made of Aluminum.

In an alternative design, instead of fixedly joining the tool elements 602, 604 to one another as described above the elements may be loosely joined by providing castellations or other correlating features on opposing surfaces of the two sections 602, 604, as depicted by the dashed line in FIG. 7. Alternative joining by means of pins in holes, etc., may also be used. In these arrangements sideways stresses between the materials as they expand and contract can be absorbed within the tool element structure by allowing sufficient space between the surface, features e.g. the castellations (omitted for clarity). In all other respects the tooling element functions in the same manner as described herein.

The surface at one end of the element 600 forms a section 614 of a tool face. When the tool element 600 is heated the first section 602 expands minimally due to the very low CTE of Invar. The second section 604, however, expands in its longitudinal direction, causing the section 614 of the tool face to move. As the depth of aluminum in the longitudinal axis of the element 600 is not constant across the cross section of the element 600, the section 614 of the tool face changes shape when it is heated. When the element 600 is cooled back to its original temperature the aluminum will contract and the tool surface 614 will revert to its original to dimension. The change in the contour of the section of tool surface 614 is a scaled reflection of the three dimensional join surface 616, between the first 602 and second 604 sections of each element 600, in a plane “A-A” perpendicular the tooling axis. Where the tool pin initially has a flat tool surface the expanded tool surface will he a direct scaled reflection of the three dimensional join surface, however where the tool surface is initially contoured in its non-extended state then the difference in dimension of the initial tool surface contour and the final tool surface contour, i.e. the expansion, will he a scaled reflection of the three dimensional join surface

Referring to FIGS. 8 and 9 a side view of an alternative element 800 is shown having a nonlinear three dimensional join surface 616.

In both variations of the element, the ratio of the scaled reflection is directly proportional to the ratio of the first and second coefficients of thermal expansion of the two materials. The total change in shape of the tool surface will be a function of the join surface geometry, the length of the tool pin, and the temperature applied. In this manner tool pins can be designed to give an exact required expansion characteristic taking into consideration other process design parameters such as the required tool temperature.

FIGS. 10 and 11 show perspective views of different elements 1000 and 1100 respectively showing how various tool contours can be provided for. The elements may have a contoured section of tool surface 1014, 1114 in their cool state, the change in the contour of the tool surface, as the element is heated, being a scaled reflection of the three dimensional join surface 1016. 1106 of the two sections 1002, 1004, 1102, 1104.

Referring to FIGS. 12 and 13, a different embodiment of the element 1200 is shown. As the material of the second section 1204 having the higher COE will also expand perpendicular the longitudinal axis of the element 1200, the second section 1204 has a smaller cross sectional area perpendicular the longitudinal axis of the element 1200. The second section 1204 is caped with a tool layer 1218 made of a material having a low COE., e.g. Invar. The cross sectional area of the second section 1204 is sufficiently smaller than the cross section of the cross sectional area of the first section 1202 that, as it heats and expands, both longitudinally and perpendicular the longitudinal axis of the element, the expanded cross section of the second section 1204 does not exceed the cross section of the first section 1202. The element will expand in the longitudinal direction in the same manner as described in relation to FIGS. 6 to 9. The tool layer 121 has a tool surface 1214 on the outer surface thereof and is attached to the second section 1204 by any suitable method as described above in relation to the joining of the first section 602 and second section 604.

A heating element (not shown) can be associated with the tool layer 1218 so that independent control of heat into and out of the work piece being molded can be achieved without this heat input/output being directly related to the expansion/contraction of the tool element geometry. The heater/cooler element could for example be an electric element or alternatively may be a channel for the passage of ambient or heated air. FIG. 14 shows a cross section through an element 1400 according to the invention which has internal heating and cooling. The element 1400 comprises a core 1420 and an outer layer 1422. The core is sized to fit tightly in the outer layer 1422 and may be attached thereto by epoxy, solder or any suitable method. Both the core and the outer layer 1422 are composite components, each being made of a material of a low CTE and a high CTE. Essentially, when assembled the element 1400 is substantially unitary and the three dimensional join surface 1424 between the two materials of the outer layer 1422 and the core 1420 is aligned. In use, as the element 1400 is heated and cooled, the element 1400 expands and contracts in the same manner as described in relation to FIGS. 6 to 9. Element 1400 has a heating/cooling fluid inlet 1428 that enters the core and passes up its center. A top channel 1430 from the end of the inlet to the outer edge of the core 1420 is formed in the top of the core and a spiral channel 1432 descends from the top channel around the outer surface of the core 1420. The core may be of any cross sectional shape but circular is preferred. When assembled in the outer layer 1422, the inlet 1428, the top channel 1430 and the spiral channel 1432 form a c ling/heating fluid pathway within the element 1400.

Referring to FIG. 15, a cross section through an alternative an element 1500: which has internal heating and cooling is shown. The element 1500 has a core 1520 and an outer layer 1522. The core has an inlet 1528 in its base for receiving heating/cooling fluid. When assembled the core 1520 is separated from the outer layer by a small gap 1534 such that, in use, heating or cooling fluid may enter the element 1500 via the inlet 1528 and then flow through the gap 1534 in the element 1500 before exiting through exit 1536. In this arrangement, only the outer layer 1522 need to have a first 1502 and a second 1504 section of different CTE, joined at a three dimensional surface 5016.

As the elements 1400, 1500 have heating/cooling passages within them, they can be directly heated and cooled much quicker than, for example, the autoclave process where beating is usually by means of forced air heating over the mold. This can decrease cycle times of the molding process.

Furthermore, as the tool elements can be individually heated total control of the timing of the expansion of the tool can be realized. For example, the tool elements may be heated in a progressive manner from one side of the tool to the other such that the expansion of the tool creates a ripple effect across the tool surface. In another example the tool elements may be sequentially heated in a manner to enhance the molding process, for example where it is necessary to expel excess resin from a mold the mold may be heated first in its middle section and the expansion progressed outwards therefrom to squeeze excess resin out of the sides of the molding. Alternatively, for example in resin transfer molding, where a preform is impregnated with resin during the molding process, areas may be left unexpanded for a period of time so as to create non compressed areas of the perform that can act as channels via which the resin can flow into the work piece. By exploiting these characteristics the overall molding process can be optimized so as to produce consistent high quality moldings.

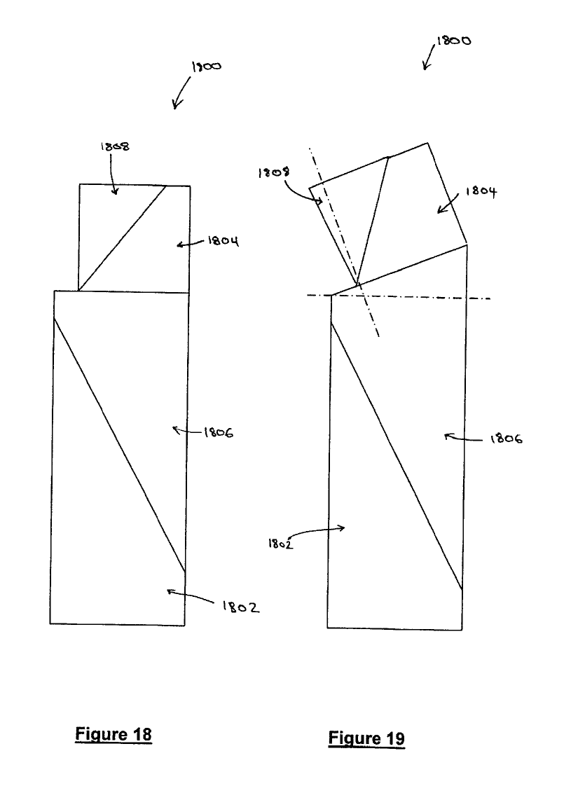

Referring now to FIG. 16, the same pre-form 100 as shown in FIG. 1 can be placed in a tooling system having elements 1600 as described herein. The tooling system is clamped around the pre-firm and heating is started. As the tooling system heats, and the workpiece consolidates, the elements 1600 expand in such a way that the tool surfaces 1614 of the system expands in proportion to the consolidation of the pre-form. As the tooling system itself is expanding as the pre-form consolidates, generally a lower clamping force can be used as tool expansion is proportionally matched to consolidation dimension change across the whole pre-form surface. In this way, the same reinforcement structure and symmetry can be maintained and a constant pressure applied during the consolidation process.

FIG. 17 shows a design how the two materials would be arranged on the elements 1700 of a tooling system 1740 to achieve the required effect for the pre-form shown.

The elements each have a first section 1702 made of a low CTE material and a second section 1704 made of a high CTE material. The join surface 1716 between low and high CTE materials is located so as to vary the ratio of low to high CTE material at a given point so as to achieve the desired local expansion of the tool. In use, the difference between the cool tooling surface 1714 shape and the heated tooling surface 1714a shape compensate for consolidation dimension changes in a pre-form.

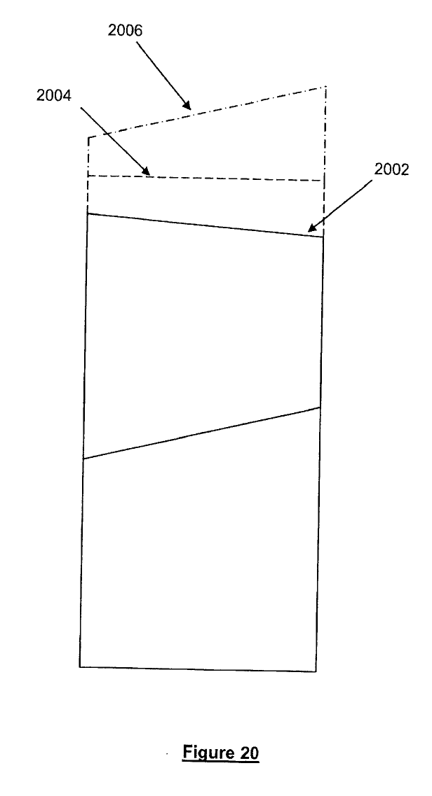

FIGS. 18 and 19 shows a side view of an element 1800 for a tooling system is shown in two temperature conditions. The element 1800 has a composite structure having first 1802 and forth sections 1804 of a first material having a first CTE and second 1806 and third 1808 sections having a second CTE. Although it is indicates that the first and forth, and the second and third, elements have the same CTE they may of course have different CTE's so as to provide the desired tool expansion upon heating. When the tool is heated the first and third sections act together in the same manner as the first and second sections described in relation to FIGS. 6 to 11 so as to provide controlled expansion of the element in the longitudinal axis of the tool and the forth and second and sections provide controlled expansion of the element in a direction perpendicular to the tool axis. As will be appreciated the sections can be used to provide expansion in any two directions that need not be perpendicular to one another. A tool of the invention can therefore be used to create such features as undercut or wrap around tool features not possible with conventional tool systems. As the tool contracts upon cooling the tool element reverts to its straight position enabling simple retraction of a workpiece free of constraint by tooling features used to create the undercut/wraparound feature.

The embodiment described with reference to FIGS. 18 and 19 may be used in combination with the heating and cooling features described with reference to FIGS. 14 and 15. In particular the supply of heating and cooling fluid may be may be independently controlled to the first and second sections or to the third and fourth sections so as to sequence the tool movement such that it expands in a first direction and then in a second direction, followed by a contraction in the second direction and a contraction in the first direction. Other sequences are of course possible and are within the scope of the invention, the pertinent feature of this aspect of the invention being the controlled sequencing of thermal expansion and contraction of tool surfaces so as to mold complex geometries that would otherwise require moving multi axis tooling. By virtue of the present invention such tooling can be provided in a simple up and down tool separation.

Referring to FIG. 20 a tool element s shown as described with reference to FIG. 6. In this embodiment however the tool is sized so that at a first temperature, which may be room temperature, the tool has a first tool face geometry 2002. The element is heated to bring the tool face geometry to a second geometry 2004. This is the starting tool geometry for the molding process. During the process the element is further heated to bring expand the element to tool geometry 2006 at which a compression is applied to the piece being molded. By having the room temperature tool geometry, when at room temperature the tool is removed from the surface of the molded part. It will be appreciated that the pressures that can be achieved by a tooling system using the elements described herein are capable of providing all the compression force needed in many tooling processes and accordingly by utilizing tool elements as described herein the necessity for providing secondary pressure in the molding process, for example by external presses, can be greatly decreased and potentially eliminated.

As will be appreciated by a person skilled in the art, various features of the invention have been described in different embodiments to clearly illustrate the features and the features shown in different Figures may be used in isolation or combined with one or more features of a different Figure where appropriate.

While certain embodiments of the inventions have been described, these embodiments have been presented by way of example only, and are not intended to limit the scope of the inventions. Indeed, the novel devices and systems s described herein may be embodied in a variety of other forms. Furthermore, various omissions, substitutions and changes in the form of the devices and systems described herein may be made without departing from the spirit of the inventions. The accompanying claims and their equivalents are intended to cover such forms or modifications as would fall within the scope and spirit of the inventions. For example, those skilled in the art will appreciate that in various embodiments, the actual structures may differ from those shown in the figures. Depending on the embodiment, certain of the steps described herein may be removed, others may he added. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

1. A composite element for a tooling system comprising a plurality of composite, elements arranged in an array to form a tool face, comprising:
a first end configured to be attached to a tool bed, a second end comprising a section of the tool face;
a first section of a first material having a first coefficient of thermal expansion, the first end being a free end of the first section, and
a second section substantially of a second material having a second coefficient of thermal expansion, the second end being a free end of the second section, the first coefficient of thermal expansion being lower than the second coefficient of thermal expansion

2. A composite element according to claim 1, wherein the first and second sections of each composite element comprise a free end and a joined end, the joined ends of the first and second sections substantially abutting one another.

3. A composite element according to claim 2, wherein the joined ends of the first and second sections comprise a plurality of intermeshing features thereon.

4. A composite element according to claim 3, wherein the intermeshing features are configured to transfer load in the longitudinal axis of the composite element and allow for relative movement of the joined ends of the first and second sections in a plane substantially perpendicular to the longitudinal axis of the composite element.

5. A composite element according to claim 2, wherein a join surface between the joined ends comprises a non-planar three dimensional surface.

6. A composite element to claim 5 wherein heating and cooling of the element result in the composite element extending and contracting in a manner so as to change a contour of the section of the tool face at its second end.

7. A composite element according to claim 6 wherein the change in the contour of the section of the tool face is a scaled reflection of the three dimensional join surface, between the first and second sections of each element, in a plane perpendicular to a longitudinal axis of the element.

8. A composite element according to claim 7, wherein the a ratio of the scaled reflection is directly proportional to a ratio of the first and second coefficients of thermal expansion.

9. A composite element according to claim 1, wherein the free end of the second section of each element comprises a capping layer of material having a low coefficient of thermal expansion.

10. A composite element according to claim 9, wherein the capping layer is configured to be at least one of heated and cooled to enable a temperature of the tool face to be controlled.

11. A composite element according to claim 1, wherein each composite element comprises an outer layer and a core.

12. A composite element according to claim 11, wherein the core comprises a first core section of a first material having a first coefficient of thermal expansion and a second core section of a second material having a second coefficient of thermal expansion, the first coefficient of thermal expansion being lower than the second coefficient of thermal expansion, and a core join surface between the first core section and the second core section comprising a three dimensional surface, the core and outer layer being in contact with one another and wherein the three dimensional core join surface is aligned with the three dimensional element join surface.

13. A composite element according to claim 11, wherein the outer layer and the core are separated from one another by a gap.

14. A composite element according to claim 1, further defining internal fluid channels for receiving heating or cooling fluid.

15. A composite, element according to claim 13, wherein the core defines internal fluid channels.

16. A composite element according to claim 15 wherein the internal fluid channels define the gap between the outer layer and the core.

17. A composite element according to claim 1, wherein the first material comprises Invar and the second material comprises aluminum.

18. A composite element according to claim 1, further comprising a third section of a material having a third coefficient of thermal expansion and a fourth section of a material having a fourth coefficient of thermal expansion, the third coefficient of thermal expansion being lower than the fourth coefficient of thermal expansion and wherein the fourth section comprises a second tool surface.

19. A composite, element according to claim 18, further comprising individually controllable heating and cooling means associated with the first and second sections and with the third and fourth sections respectively.

20. A tooling system, comprising:
a plurality of composite elements arranged in a first array, each composite element comprising:
a first end configured to be attached to a tool bed and a second end defining a first tool face;
a first section of a first material having a first coefficient of thermal expansion, the first end being a free end of the first section, and
a second section substantially of a second material having a second coefficient of thermal expansion, the second end being a free end of the second section, the first coefficient of thermal expansion being lower than the second coefficient of thermal expansion

21. A tooling system according to claim 20, further comprising a second plurality of composite, elements each defining a first end and a second end and arranged in a second array such that the second ends of each composite element of the second array form a second tool face, the first and second tool faces being configured in an opposing arrangement.

22. A tooling system according to claim 20, wherein the second section of each composite element is dimensioned such that when the composite elements are arranged in the first array, a gap is defined between the second sections of adjacent elements.

23. A tooling system according to claim 20, wherein at least some of the plurality of composite elements are dimensioned such that at a first temperature a first surface is oversized compared to a required first tool surface geometry and wherein at a second temperature, higher than the first temperature the composite elements expand to form the required first tool surface geometry.

24. A tooling system according to wherein at a third temperature higher than the second temperature at least some of the composite elements further expand to form a required second tool surface geometry.
